(19) United States
(12) Patent Application Publication
(10) Pub. No.: US 2007/0256049 A1
(43) Pub. Date: Nov. 1, 2007

(54) Systems and methods for providing a status management service

(75) Inventors: Julien Delvat, Antibes Juan les Pins (FR); Roman Rapp, Villeneuve Loubet (FR)

Correspondence Address: SAP / FINNEGAN, HENDERSON LLP, 901 NEW YORK AVENUE, NW, WASHINGTON, DC, 20001-4413, US

(73) Assignee: SAP AG

(21) Appl. No.: 11/508,138

(22) Filed: Aug. 23, 2006

(30) Foreign Application Priority Data
Apr. 28, 2006 (EP) 06290712.6

(51) Int. Cl. G06F 9/44

(52) U.S. Cl. 717/104

(57) ABSTRACT

Systems and methods are provided for implementing a service-oriented architecture. The service-oriented architecture may include a plurality of foundation business objects and at least one dependent business object for providing a status management service for the plurality of foundation business objects

### TECHNICAL FIELD

The present invention generally relates to data processing systems and methods, and more particularly to status management services in a service-oriented architecture.

### BACKGROUND INFORMATION

A service-oriented architecture (SOA) includes a collection of data processing services that can communicate with each other. The communication may involve data exchange and/or two or more services coordinating activities or data processing tasks. Conventional SOAs have some connecting infrastructure to provide communication between the data processing services and coordination.

Examples of known art service-oriented architectures include Distributed Component Object Model (DCOM), based on the Common Object Request Broker Architecture (CORBA), which can interoperate with any other CORBA-based program across multiple operating systems, programming languages and networks. DCOM, an extension of the Component Object Model (COM), is designed for use across multiple network transports, including Internet protocols such as HTTP. DCOM works with both Java Applets and activeX components through its use of the COM.

SAP Enterprise Services Architecture (ESA), commercially available from SAP AG (Walldorf, Germany), is another recent service-oriented architecture. ESA extends web services standards and services-oriented architecture principles to meet the needs of enterprise business solutions. ESA helps information technology (IT) organizations leverage existing systems to build and deploy flexible solutions that support end-to-end business scenarios across heterogeneous data processing systems.

### SUMMARY OF THE INVENTION

Embodiments of the present invention relate to improved data processing systems, methods, and computer program products that facilitate the provision of a status management service in a service-oriented architecture.

In accordance with an embodiment of the present invention, there is provided a data processing system having a service-oriented architecture, the service-oriented architecture comprising a plurality of foundation business objects and a dependent business object for providing a status management service for the plurality of foundation business objects.

Embodiments of the present invention may advantageously provide a central status management service that may be used by multiple instances of various foundation business objects. In particular, embodiments of the present invention may reduce the complexity of foundation business objects by eliminating the need for status management program routines specific to a respective foundation business object. Such specific program routines can be replaced by a generic status management service based on a dependent business object. For managing the status of a given instance of one of the foundation business objects, an instance of the dependent business object may be created that provides a status management service and interacts with this instance of the foundation business object.

In accordance with an embodiment of the invention, the foundation business objects have an interface to the dependent business object, comprising a first set of methods for interoperability of an instance of the respective foundation business object with its dependent instance of the dependent business object.

In accordance with another embodiment of the invention, the first set of methods comprises a first method for getting a status of the instantiated foundation business object from the instantiated dependent business object, a second method for setting the status of the instantiated foundation business object, and a third method for signaling that the status of the instantiated foundation business object has changed.

In accordance with another embodiment of the invention, the dependent business object comprises a second set of methods, the second set of methods comprising a first method for getting a default status of the instantiated foundation business object, a second method for getting the possible statuses of the instantiated foundation business object, a third method for getting the possible actions that can be performed on the instantiated foundation business object, a fourth method for checking whether execution of a given action on the instantiated foundation business object is allowed, a fifth method for setting the status of the instantiated foundation business object, a sixth method for getting the status of the instantiated foundation business object, and a seventh method for saving the actual status of the instantiated foundation business object.

In accordance with another embodiment of the invention, the data processing system comprises a configuration component for configuring the status management service. The configuration component stores data describing actions that can be performed on at least some of the foundation business objects.

In accordance with another embodiment of the invention, allowed actions are specified for each status and allowed statuses are assigned to each foundation business object in the configuration component.

In accordance with another embodiment of the invention, allowed actions that can be performed on an instantiated foundation business object are specified per foundation business object and depend on the status of the instantiated foundation business object.

In accordance with another embodiment of the invention, the allowed actions that can be performed on an instantiated foundation business object are specified on a foundation business object key basis.

In accordance with another embodiment of the invention, the data processing system has a volatile main memory for temporarily storing the actual status of an instantiated foundation business object. In response to a command to save a status, the actual status is persistently stored in a database of the data processing system.

In accordance with another embodiment of the invention, allowed actions that can be performed on an instantiated foundation business object are obtained from the respective instantiated dependent business object before one of the allowed actions is executed by an application program.

In accordance with another embodiment of the invention, the data processing system has a user interface for displaying the actual statuses of instantiated foundation business objects. The user interface may provide a context menu for showing allowed actions that can be executed with respect to a selected one of the instantiated foundation business objects.

Another aspect of the present invention relates to a data processing method comprising a service-oriented architecture, the service-oriented architecture comprising a plurality of foundation business objects and a dependent business object to provide a status management service for the plurality of foundation business objects, the method comprising instantiation of one of the foundation business objects, initiation of the instantiation of the dependent business object by the instantiated one of the foundation business objects, and receiving a status by the instantiated one of the foundation business objects from the instantiated dependent business object.

Still another aspect of the present invention relates to a computer readable medium for performing such data processing.

It is to be understood that both the foregoing general description and the following detailed description are exemplary and explanatory only, and should not be considered restrictive of the scope of the invention, as described in the claims. Further, features and/or variations may be provided in addition to those set forth herein. For example, embodiments consistent with the present invention may be directed to various combinations and sub-combinations of the features described in the following detailed description.

### BRIEF DESCRIPTION OF THE DRAWING

The accompanying drawings, which are incorporated in and constitute a part of the specification, illustrate embodiments of the invention and, together with the description, serve to explain advantages and principles of the invention. In the drawings:

FIG. 1 is a block diagram of an exemplary data processing system having a service-oriented architecture for providing a status management service;

FIG. 2 is a class diagram illustrating exemplary foundation business objects having an interface to provide interoperability with a dependent business object that provides the status management service;

FIG. 3 illustrates the exemplary structure of the dependent business object;

FIG. 4 illustrates a first configuration of the status management service;

FIG. 5 illustrates a second configuration of the status management service;

FIG. 6 illustrates a third configuration of the status management service;

FIG. 7 is a flowchart illustrating an exemplary embodiment of a method, consistent with an embodiment of the invention;

FIG. 8 is a sequence diagram illustrating the exemplary assignment of a default status to an instantiated foundation business object by the status management service;

FIG. 9 is a sequence diagram illustrating the exemplary execution of a status change of an instantiated foundation business object using the status management service;

FIG. 10 is a sequence diagram illustrating exemplary communication of allowed actions that can be performed on an instantiated foundation business object from the status management service;

FIG. 11 schematically shows an exemplary user interface for displaying of status information per instantiated foundation business object; and

FIG. 12 schematically shows an exemplary user interface comprising a context menu;

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible without departing from the spirit and scope of the invention. For example, substitutions, additions, or modifications may be made to the components illustrated in the drawings, and the exemplary method described herein may be modified by substituting, reordering, or adding steps to the disclosed methods. Accordingly, the following detailed description does not limit the invention. Instead, the proper scope of the invention is defined by the appended claims.

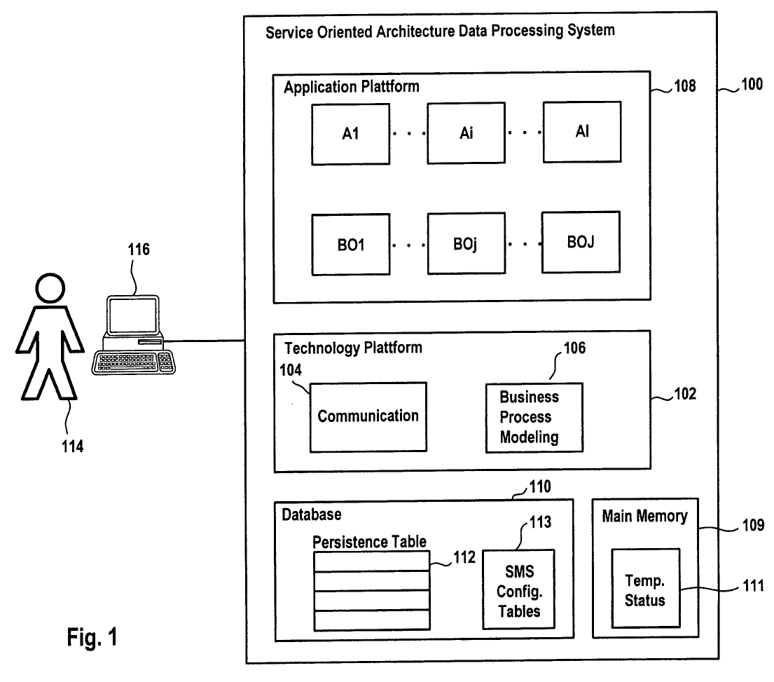

FIG. 1 shows an exemplary data processing system 100 that has a service-oriented architecture such as SAP's Enterprise Services Architecture (ESA). The data processing system 100 can be physically distributed over a number of computer systems that are interconnected by one or more networks. Further, the various networked computer systems constituting the data processing system 100 can use a number of different operating systems and programming languages.

The service-oriented architecture has a technology platform 102 that provides the “glue” that binds various computer systems to form the data processing system 100. Technology platform 102 has a communication component 104 that enables the exchange of data across the various computer systems and networks. For example, communication component 104 can be implemented by SAP's Exchange Infrastructure (XI).

The technology platform 102 has a business process modeling component 106 that serves to coordinate the interchange of data in the service-oriented architecture in accordance with certain business procedures. It can be implemented, for example, by the product ARIS that is commercially available from IDS Scheer. The service-oriented architecture of data processing system 100 has an application platform 108 that uses the infrastructure provided by the technology platform 102 and implements business logic. The application platform 108 has an arbitrary number I of application programs A1, . . . , Ai, . . . , Al.

Further, application platform 108 has an arbitrary number “J” of business objects BO1, . . . , BOj, . . . , BOJ. The business objects of application platform 108 may be implemented as SAP business objects. The services of SAP business objects describe complete elementary steps in business processes, such as making a purchase order, providing a product cost estimate, invoicing a customer for a service, etc. These services can be implemented as methods of Business Objects (“BO”). The encapsulation of the description of a complete business process in such a business object reduces complexity because the inner structure of the business object remains concealed. By invoking services of the business objects, the external applications A1, . . . , Al can access and manipulate the business objects BO1, . . . , BOJ, via the Internet, SAP Exchange Infrastructure (Xl), DCOM or CORBA, or the like.

While the individual business objects describe complete elementary steps in business processes, the business process modeling component 106 of the technology platform 102 describes complex workflows that involve multiple business processes steps and thus respective business objects services.

For this embodiment of the invention, two kinds of business objects are relevant: foundation business objects and dependent business objects. By definition, an instantiated foundation business object is not dependent on any other business object or instance of a business object. By definition, an instantiated dependent business object has a dependency relationship with an instantiated foundation business object.

Data processing system 100 has at least one database 110. The database 110 can be a single physical database or it can be a distributed database using multiple computer systems of the data processing system 100. Database 110 serves as storage of persistence tables 112 for storage of instances of business objects and events, enabling the interchange of asynchronous messages and auditing of the business processes. Further, at least one of persistence tables 112 serves as storage of the statuses of the instances of foundation business objects.

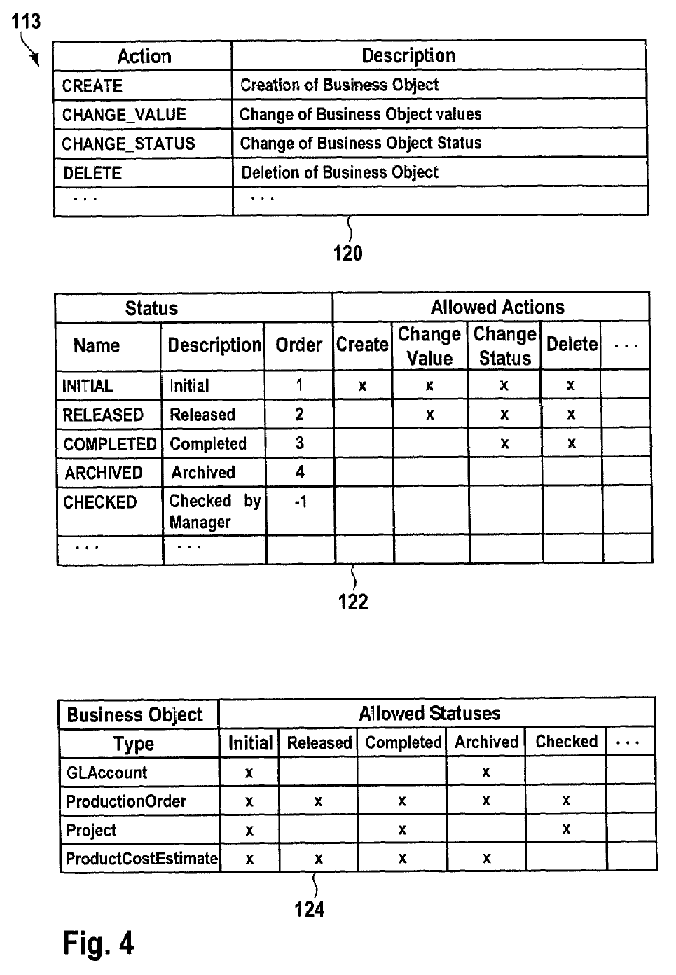

One or more tables 113 are stored in the database 110 for storage of a configuration of the status management service (SMS). For example, tables 113 may specify the actions that can be performed on instances of foundation business objects; the statuses that at least some of the instances of the foundation business objects can take; and/or actions that can be performed on instantiated foundation business objects depending on status and/or foundation business object type and/or foundation business object keys. Examples of the structure and content of tables 113 are given below in FIGS. 4, 5 and 6.

The data processing system 100 has a volatile main memory 109 for storing a temporary status 111 of an instantiated foundation business object that is currently being processed, for example, by one of the external applications. The temporary status 111 is the actual status of the respective instantiated foundation business object that is temporarily held in the main memory 109. After processing of the instantiated foundation business object is successfully completed, a save command is received, for instance, from the external application that has performed the processing such that the temporary status 111 is stored in the respective persistence table 112. A respective status that has been previously stored in the persistence table 112 for that instantiated foundation business object may be overwritten by the temporary status 111 in response to the save command. If execution of the external application is terminated unsuccessfully the temporary status 111 is not stored in the persistence table 112, and the original status is kept.

By way of example, FIG. 1 shows a user 114 and his or her personal computer 116 that is coupled to the data processing system 100. Although only one user 114 is illustrated, data processing system 100 may be coupled to any number of users depending on, for example, the size of the organization that operates the system 100.

User 114 may be an employee who performs a certain action, item or task requiring the use of one or more of the external application programs Al . . . Al of the application platform 108 and instantiation of one or more of the foundation business objects of the application platform 108.

For execution of the action item, the user 114 enters data into his or her personal computer 116 for instantiating the respective foundation business object that implements the elementary business process for execution of the action item.

Alternatively one of the external application programs A1-Al is invoked automatically and instantiates one or more of the foundation business objects without user interaction.

At least one of the business objects BO1, . . . BOj contained in the application platform 108 is not a foundation business object but a dependent business object. A service of a dependent business object also describes an elementary business process step. However, the dependent business object differs from a foundation business object in that an instantiated dependent business object requires a dependency relationship to an instantiated foundation business object.

For example, the business object for making a production order is the business object BO1. In this instance, user 114 enters data into his or her personal computer 116 for instantiating the business object BO1. The instantiated business object BO1 initiates the instantiation of a dependent business object BOj that provides the status management service. After instantiation of the dependent business object BOj, the instantiated dependent business object BOj executes the status management service as specified in the tables 113 in order to provide an initial status, to execute a status change and/or to communicate allowed actions that can be performed on the initiated foundation business object depending on its actual status.

Implementing the steps of a status management process in a separate dependent business object has the advantage that no such status management process needs to be included into the various foundation business objects. This can substantially reduce the quantity of software (e.g., lines of programming code) required for implementation of the foundation business objects.

Another advantage is increased flexibility. If the status management process needs to be changed, only the dependent business object that provides the status management service and/or one of the tables 113 needs to be changed correspondingly, but not the foundation business objects themselves.

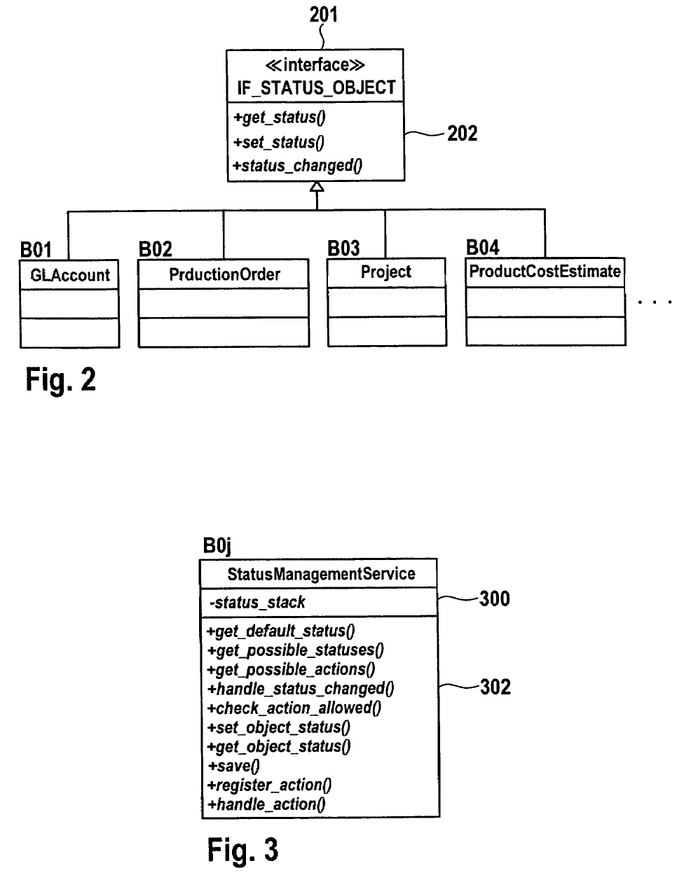

FIG. 2 schematically shows an interface 201 that is implemented by exemplary foundation business objects in order to provide interoperability with the dependent business object BOj that provides the status management service. In the example considered here, there are foundation business objects BO1 “general ledger (GL) account,” BO2 “production order,” BO3 “project,” BO4 “product cost estimate,” etc.

The interface 201 contains a number of methods 202 such as the method “get status” for getting a status of the respective instantiated foundation business object, “set status” for setting an updated status, and “status changed” for signaling that the status has been changed.

FIG. 3 schematically shows an exemplary structure of the dependent business object BOj that provides the status management service, if instantiated. The business object BOj has a header 300 that contains a status stack and a body 302 that contains various methods and class methods, including get_default_status, get_possible_statuses, get_possible_actions, handle_status_changed, check_action_allowed, set_object_status, get_object_status, save, register_action, and handle_action.

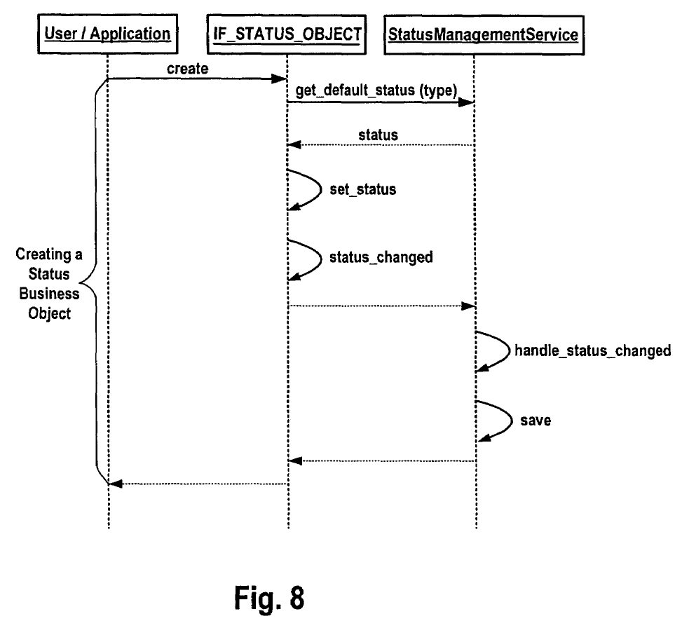

The difference between a method and a class method is that a method can be called after instantiation, whereas a class method can be called before instantiation of the dependent business object. The functionalities of these methods and class methods will be explained in more detail below with reference to FIGS. 8, 9 and 10.

FIG. 4 shows a more detailed example of an implementation of the tables 113 that configure the status management service. In the embodiment considered here, the status management service configuration tables 113 include three tables 120, 122 and 124. The table 120 contains a definition of the actions that can be performed on at least some of the foundation business objects. This may comprise the action “create” for creation of a new instance of a foundation business object, “change value” for changing one or more values of an instantiated foundation business object, “change status” for changing the status of an instantiated foundation business object, and “delete” for deletion of an instantiated foundation business object, etc.

Table 122 contains a definition of the statuses that can be taken by at least some of the foundation business objects. A set of allowed actions is assigned to each of the statuses in order to specify the actions that can be performed on an instantiated foundation business object in that status.

For instance, the allowed actions create, change value, change status, and delete are assigned to the status “initial,” the allowed actions change value, change status and delete are assigned to the status “released,” and the allowed actions change status and delete are assigned to the status “completed.” No allowed actions are assigned to the statuses “archived” and “checked.”

In addition, table 122 specifies the order in which an instantiated foundation business object can transition from one of the defined statuses to another. In the embodiment considered here, this order is as follows: 1=initial, 2=released, 3=completed, 4=archived. In other words, an instantiated foundation business object may transition from initial to released to completed and finally to archived only in this specified order. The status “checked” has no order and is indicated by order=-1 in the table 122. This means that the status “checked” can be taken by an instantiated foundation business object independently from the other defined statuses.

The table 124 specifies the allowed statuses for each of the foundation business objects. An instance of the foundation business object GL-Account can take one of the allowed statuses initial or archived. An instance of the foundation business object Production Order can take one of the allowed statuses initial, released, completed, archived or checked. An instance of the foundation business object Project can take one of the allowed statuses initial, completed or checked. An instance of the foundation business object Product-Cost Estimate can take one of the allowed statuses initial, released, completed, archived. For example, in conjunction with the table 122, this means that an instance of the foundation business object project can transition from initial to completed to checked in accordance with the order specified in table 122, leaving out those statuses that are not allowed for the considered foundation business object.

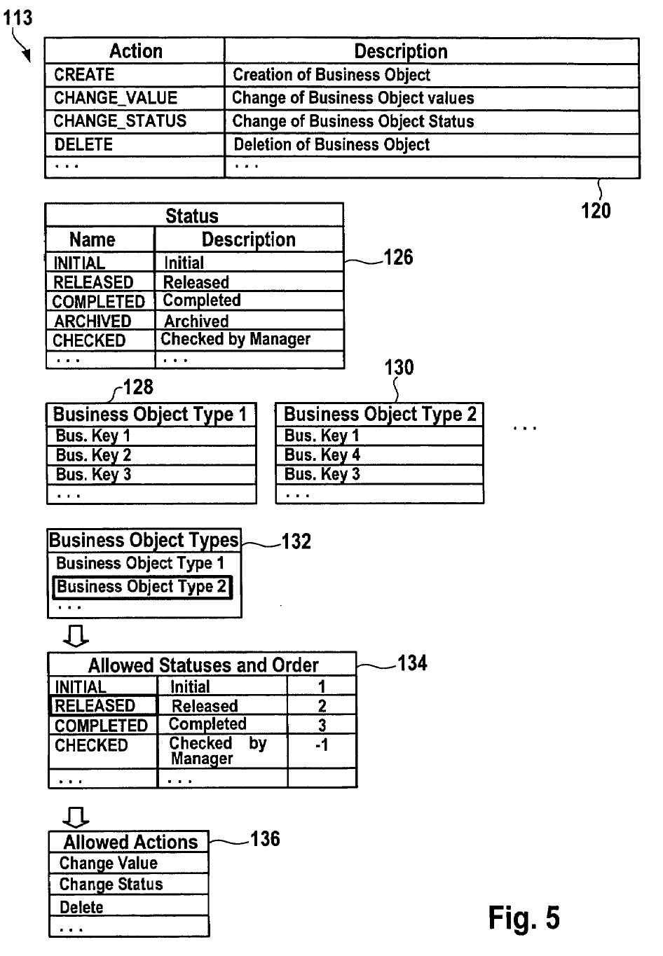

FIG. 5 shows another an exemplary implementation of tables 113 for specifying the status management service. In the embodiment considered here, the status management service is configured by the table 120 (cf. FIG. 4) and by the tables 126, 128, 130, 132, 134 and 136. Table 126 specifies the statuses that at least some of the foundation business objects can take without assigning allowed actions and without specifying an order, which is in contrast to the table 122 in the implementation considered with respect to FIG. 4. The configuration of the status management service is implemented here depending on business object types; Table 128 contains a list of business object keys for a given foundation business object of type 1, such as BO1. Likewise, the table 130 contains such a list for B02. Table 132 contains a list of the business object types. Each item in table 132 points to a specific table that is assigned to that entry. For example, table 134 is assigned to the entry “business object type 2” of table 132. Table 134 specifies the allowed statuses and the order of the statuses with respect to that business object type 2.

A separate table is assigned to each of the statuses specified in these specific tables (e.g., table 134). For example, the entry into table 134 for the status “released” points to table 136 containing the allowed actions that can be performed on an instantiated foundation business object of the business object type 2 if it has the status “released.”

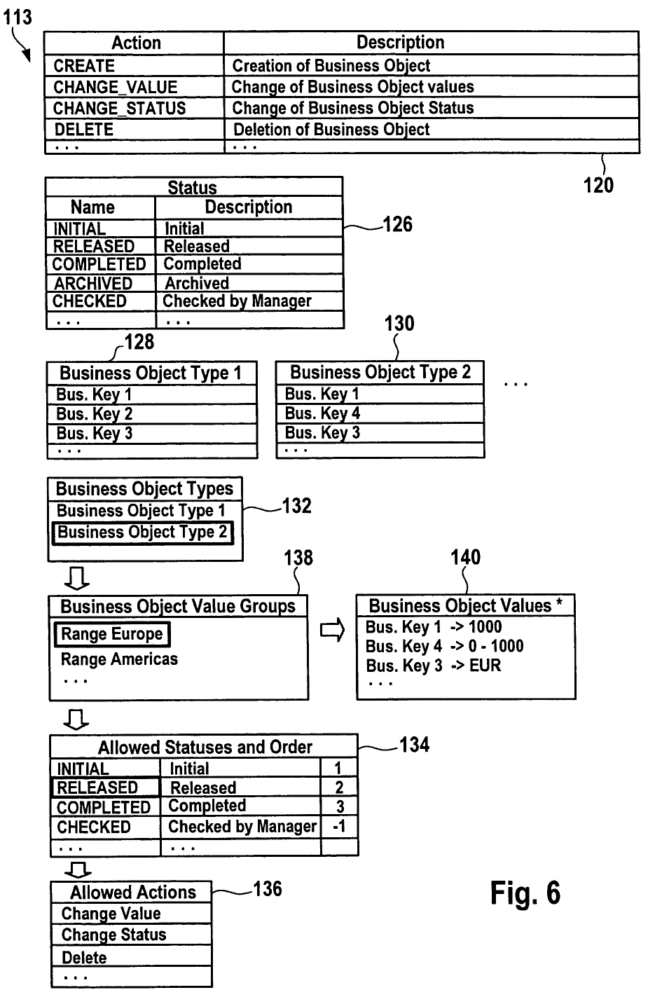

FIG. 6 shows still another implementation of the tables 113. In the embodiment considered here the configuration of the status management service is made dependent on business object keys. The tables 120, 126, 128, 130, 132, 134 and 136 are identical or similar to the implementation considered with respect to FIG. 5, except that table 132 is not directly linked to table 134, but, instead, to a table 138, which specifies business object value groups on a per business object type basis. Table 138 points to respective business object values where a business object value can be defined as a single value or a range or exception values or exception ranges.

This implementation is advantageous for applications requiring a configuration that depends on the business object keys rather than on the business type. For example, the statuses “initial,” “released,” “completed,” and “checked” are allowed for the business object type with respect to the value “Range Europe.” For status “released,” only actions “change value,” “change status” and “delete” are allowed.

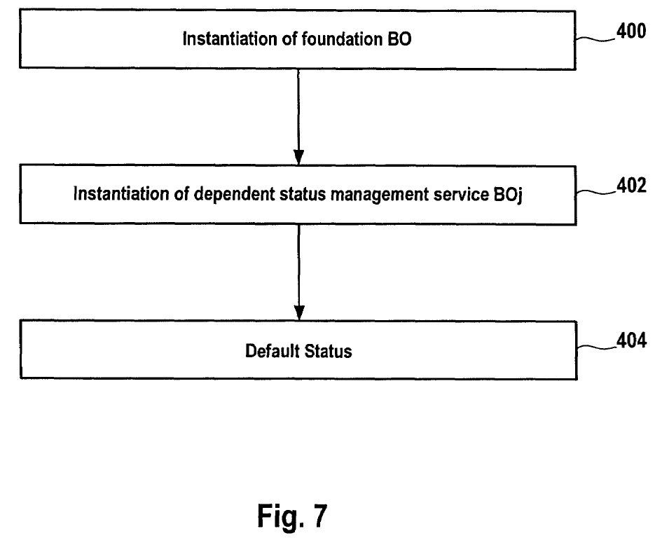

FIG. 7 is a flowchart illustrating an embodiment of a method consistent with an embodiment of the invention. In step 400, one of the foundation business objects is instantiated automatically or by involving some degree of user interaction. In order to provide a status management service for the instantiated foundation business object the dependent business object BOj is instantiated in step 402. In response to a respective method call, the instantiated dependent business object BOj provides the default status to the instantiated foundation business object in step 404.

FIG. 8 shows a sequence diagram illustrating a more detailed embodiment of the method of FIG. 7, making reference to the methods as shown in FIGS. 2 and 3. The sequence diagram involves the objects “user/application” (cf. user 114 and one of the applications of the application platform 108 of FIG. 1), “IF status object” (cf. interface 201 as shown in FIG. 2) and “status management service”; in other words, an instance of the dependent business object BOj for providing the status management service as depicted in FIG. 3.

When an instance of one of the foundation business objects is created, it receives a default status defining the actions that can or cannot be performed on it. First, the user 114 or an application instantiates one of the foundation business objects (e.g., a production order for an existing product) including the respective IF Status Object interface 201. By means of the interface 201, the method get_default_status of the status management service BOj is called in order to set an initial status by means of the method set status of the interface 201. This done, the instantiated foundation business object raises the status changed event by means of its interface 201. This event message triggers the status management service in order to handle that message with handle status changed. Finally the changed status is persistently saved in one of the persistence tables 112 (cf. FIG. 1).

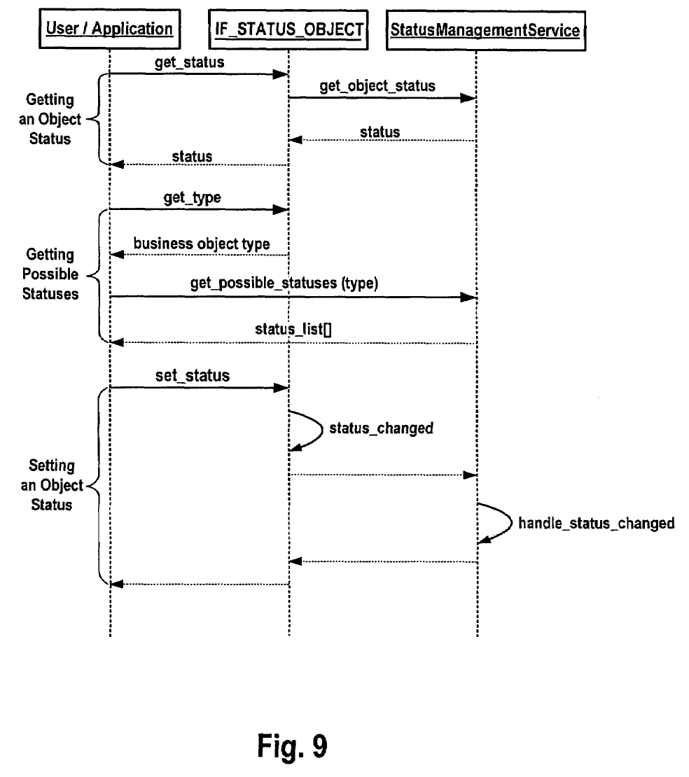

FIG. 9 shows a sequence diagram for changing a status during the lifecycle of the instantiated business object. In the illustrated embodiment, the status of the instantiated foundation business object can be retrieved and/or changed by the user 114 or an application. With each change the status management service ensures that dependent objects also have their status changed correspondingly in order to keep the data model synchronized with the database, if necessary.

After the actual status of the instantiated foundation business object has been obtained by calling the methods “get status” and “get object status,” the user or the application can obtain possible statuses to which the instantiated foundation business object can transition from its actual status by means of the method “get type” and “get possible statuses.” A status change can be performed by calling the method “set status.”

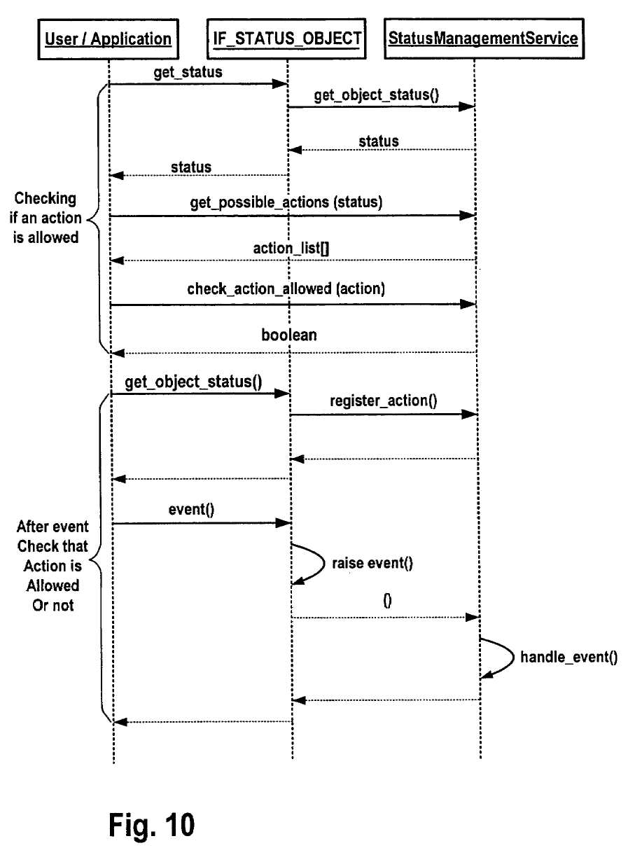

FIG. 10 shows a sequence diagram illustrating an exemplary interchange of messages and method calls for checking if an action is allowed. Checking whether an action is allowed can be performed by calling the methods “get status,” “get object status,” “get possible actions (status),” and “check action allowed (action).” Alternatively or in addition such a check is performed after an event using the methods get object status, register action, event, raise event and handle event.

FIG. 11 schematically shows a window 500 of an exemplary user interface of the data processing system 100. For example, the window 500 is displayed on the screen of a personal computer 116 (cf. FIG. 1). The window 500 shows the names of instantiated foundation business objects BOX, BOY, BOZ, and their respective statuses. The list of the instantiated foundation business objects can be structured hierarchically such as by means of an object tree. The status information shown in window 500 can be obtained by means of the status management service provided by respective instantiated dependent business objects.

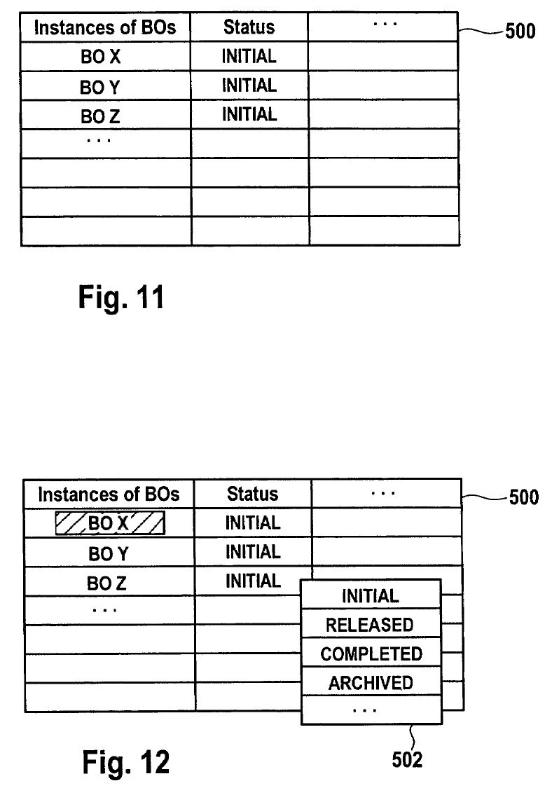

FIG. 12 shows a context menu 502 displayed in the window 500. In the example considered here, the context menu 502 opens, e.g., by selecting one of the instances of the foundation business object shown in the window 500, and then performing an input action, such as clicking the right mouse button for invocation of the status management service. For example, the user 114 has selected the instance BO X and has clicked on the right mouse button in order to open the context menu 502.

Context menu 502 shows the allowed statuses of the selected instance X in the correct order. As a consequence, the user is informed regarding the allowed statuses of instance X and the order in which instance X can transition from one allowed status to another.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Computer programs based on the written description and flow charts of this invention are within the skill of an experienced developer and/or programmer. The various programs or program content can be created using any of the techniques known to one skilled in the art or can be designed in connection with existing software. For example, programs or program content can be designed in or by means of Java, C++, HTML, XML, or HTML with included Java applets or in SAP R/3 or ABAP. One or more of such content can be integrated in existing e-mail or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

As disclosed herein, embodiments and features of the invention may be implemented through computer-hardware and/or software. Such embodiments may be implemented in various environments, such as networked and computing-based environments with one or more users. The present invention, however, is not limited to such examples, and embodiments of the invention may be implemented with other platforms and in other environments.

By way of example, embodiments of the invention may be implemented using conventional personal computers (PCs), desktops, hand-held devices, multiprocessor computers, pen computers, microprocessor-based or programmable consumer electronics devices, minicomputers, mainframe computers, personal mobile computing devices, mobile phones, portable or stationary personal computers, palmtop computers or the like.

The storage mediums and databases referred to herein symbolize elements that temporarily or permanently store data and instructions. Although storage functions may be provided as part of a computer, memory functions can also be implemented in a network, processors (e.g., cache, register), or elsewhere. While examples of databases have been provided herein, various types of storage mediums can be used to implement features of the invention, such as a read only memory (ROM), a random access memory (RAM), or a memory with other access options. Further, memory functions may be physically implemented by computer-readable media, such as, for example: (a) magnetic media, like a hard disk, a floppy disk, a magnetic disk, a tape, or a cassette tape; (b) optical media, like an optical disk (e.g., a CD-ROM), or a digital versatile disk (DVD); (c) semiconductor media, like DRAM, SRAM, EPROM, EEPROM, memory stick, and/or by any other media, like paper.

Embodiments of the invention may also be embodied in computer program products that are stored in a computer-readable medium or transmitted using a carrier, such as an electronic carrier signal communicated across a network between computers or other devices. In addition to transmitting carrier signals, network environments may be provided to link or connect components in the disclosed systems. Networking environments are commonplace in offices, enterprise-wide computer networks, intranets and the Internet (i.e., the World Wide Web). The network can be a wired or a wireless network. To name a few network implementations, the network is, for example, a local area network (LAN), a wide area network (WAN), a public switched telephone network (PSTN), an Integrated Services Digital Network (ISDN), an infrared (IR) link, a radio link, such as a Universal Mobile Telecommunications System (UMTS), Global System for Mobile Communication (GSM), Code Division Multiple Access (CDMA), or a satellite link.

While certain features and embodiments of the invention have been described, other embodiments of the invention will be apparent to those skilled in the art from consideration of the specification and practice of the embodiments of the invention disclosed herein. Further, the steps of the disclosed methods may be modified in any manner, including by reordering steps and/or inserting or deleting steps, without departing from the principles of the invention.

It is therefore intended that the specification and examples be considered as exemplary only, with a true scope and spirit of the invention being indicated by the following claims.

What is claimed is:

1. A data processing system for executing instructions stored on computer-readable media and having a service-oriented architecture, said data processing system comprising:
a plurality of foundation business objects; and
at least one dependent business object for providing a status management service for the plurality of foundation business objects.

2. The data processing system of claim 1, further comprising:
means for instantiating one of the plurality of foundation business objects; and
means for instantiating at least one dependent business object.

3. The data processing system of claim 2, said plurality of foundation business objects further comprising an interface, wherein said interface comprises:
means for determining a status of the instantiated foundation business object from the instantiated dependent business object;
means for setting the status of the instantiated foundation business object; and
means for signaling that the status of the instantiated foundation business object has changed.

4. The data processing system of claim 3, said dependent business object further comprising:
means for determining a default status of the instantiated foundation business object;
means for determining the possible statuses of the instantiated foundation business object;
means for determining the possible actions that can be performed on the instantiated foundation business object;
means for checking if execution of a given action on the instantiated foundation business object is allowed;
means for setting the status of the instantiated foundation business object;
means for determining the status of the instantiated foundation business object; and
means for saving the actual status of the instantiated foundation business object.

5. The data processing system of claim 1, further comprising a configuration component for configuring the status management service, wherein said configuration component comprises:
means for storing first data descriptive of actions that can be performed on at least some of the foundation business objects.

6. The data processing system of claim 5, said configuration component further comprising:
means for storing second data descriptive of allowed statuses of at least some of the foundation business objects and allowed actions that are assigned to the allowed statuses.

7. The data processing system of claim 6, wherein said second data describes an order of the statuses.

8. The data processing system of claim 7, said configuration component further comprising:
means for storing third data describing allowed statuses assigned to a type of business object.

9. The data processing system of claim 5, said configuration component further comprising:
means for storing second data describing statuses of at least some of the foundation business objects;
means for storing third data describing business object types;
means for storing fourth data describing allowed statuses for each said type of business object; and
means for storing fifth data describing allowed actions for each of said statuses.

10. The data processing system of claim 5, said configuration component further comprising:
means for storing allowed statuses depending on business object keys.

11. The data processing system of claim 1, further comprising:
a main memory for storing a temporary status of an instantiated foundation business object; and
a database table for storing the status of the instantiated foundation business object, wherein the temporary status is persistently stored in the database in response to a command.

12. The data processing system of claim 5, further comprising:
at least one application program, said application program being adapted to obtain allowed actions that can be performed on an instantiated foundation business object from said configuration component.

13. The data processing system of claim 1, further comprising:
a user interface for displaying the statuses of instantiated foundation business objects.

14. The data processing system of claim 13, said user interface further comprising:
means for providing a context menu for indicating allowed actions that can be performed on an instantiated foundation business object.

15. A data processing method for a service-oriented architecture, the service-oriented architecture comprising a plurality of foundation business objects, and a dependent business object for providing a status management service for the plurality of foundation business objects, the method comprising:
instantiating one of the foundation business objects;
initiating the instantiation of the dependent business object by the instantiated one of the foundation business objects; and
receiving a status by the instantiated one of the foundation business objects from the instantiated dependent business object.

16. The data processing method of claim 15, further comprising:
getting allowed statuses from the instantiated dependent business object for the instantiated foundation business object; and
changing the status of the instantiated foundation business object to one of the allowed statuses.

17. The data processing method of claim 15, further comprising:
obtaining allowed actions that can be performed on the instantiated foundation business object from the instantiated dependent business object; and
executing one of the allowed actions by an application program.

18. The data processing method of claim 15, further comprising:
checking whether an action to be performed on the instantiated foundation business object is allowed based on the instantiated dependent business object.

19. The data processing method of claim 15, further comprising:
temporarily storing an actual status of the instantiated foundation business object in a volatile memory; and
persistently storing the actual status in a database in response to a command.

20. A computer program product comprising executable instructions for performing the method of claim 15.
